(19) United States
(12) Patent Application Publication
(10) Pub. No.: US 2009/0125123 A1
(43) Pub. Date: May 14, 2009

(54) Computer having an auto-flipping screen and a method for automatically flipping the screen of the computer

(76) Inventor: Ting-Chun Lu, Tsao Tuen (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/979,856

(22) Filed: Nov. 9, 2007

(51) Int. Cl. G05B 11/01

(52) U.S. Cl. 700/13

(57) ABSTRACT

A computer having an auto-flipping screen and a method for automatically flipping the screen of the computer are disclosed. The computer includes a base, a transmission module, and a screen. In the base, there is a motherboard, and the motherboard is installed with a BIOS, a south bridge chip, and a transmission controller. The south bridge chip controls the communication between the BIOS and the transmission controller. The transmission module is controlled by the transmission controller. The screen performs a flipping operation to the base according to the operation of the transmission module. The transmission controller controls the transmission module according to a default value in the BIOS to automatically flip the screen to a location with an angle.

### BACKGROUND OF THE INVENTION

1. Field of the Invention

The present invention relates to a computer having an auto-flipping screen and a method for automatically flipping the screen of the computer. In particular, this invention relates to a computer having an auto-flipping screen and a method for automatically flipping the screen that utilize the BIOS to control the location of the screen when the computer is turned on or turned off.

2. Description of the Related Art

The computer BIOS can access the RAM manufactured by the CMOS. The BIOS reads data from the RAM to obtain the computer configuration, or stores the computer configuration to the RAM used for turning on the computer.

Generally, when a computer is turned on, the BIOS performs a starting test procedure to check, detect and set the system status. If the user does not wish to enter the setup menu, the computer starting process is finished. If the user enters into the setup menu, the BIOS enters the setup procedure so that the user can change the computer configuration, store the modified configuration to the CMOS memory, and quit out from the setup menu. When the setup procedure is finished, the computer is restarted immediately according to the modified configuration.

Furthermore, for a laptop, the user needs to manually open or close the screen located above the base. However, it has some problems for the user to manually open or close the screen. Firstly, the user needs to open the lock. Next, the user needs to adjust the angle between the screen and the base according to the personal viewing location. By manually adjusting the angle between the screen and the base, the jointed structure of the laptop may be damaged due to the user's improper force. At the same time, when the user turns on the computer again, the user needs to adjust the angle between the screen and the base. It is time-consuming, and it is inconvenient for the user.

### SUMMARY OF THE INVENTION

One particular aspect of the present invention is to provide a computer having an auto-flipping screen. The computer utilizes the BIOS to control the angle between the screen and the base. When the computer is turned off, the angle between the screen and the base is stored in the CMOS memory. When the computer is turned on again, the screen is flipped to the location with the stored angle. Thereby, when the computer is turned on or turned off, the computer utilizes the BIOS to achieve the function of automatically opening or closing the screen. The problem of the jointed structure being damaged by using a manual method and the inconvenient problem caused by adjusting the screen are overcome.

The computer having an auto-flipping screen includes a base, a transmission module, and a screen. In the base, there is a motherboard, and the motherboard is installed with a BIOS, a south bridge chip, and a transmission controller. The south bridge chip is connected with the BIOS and the transmission controller for controlling the communication between the BIOS and the transmission controller. The transmission module is electrically connected with the transmission controller, and is controlled by the transmission controller. The screen is pivoted to the transmission module. The transmission controller controls the transmission module according to a default value in the BIOS to automatically flip the screen to a location with an angle.

The present invention also discloses a method for automatically opening the screen of the computer. Firstly, the BIOS of the computer determines whether the screen is closed or not according to a judging signal outputted from the GPIO. When the screen of the computer is not closed, the BIOS performs a normal starting procedure. When the screen of the computer is closed, the BIOS determines the setting mode for opening the screen of the computer, including an automatic mode and a manual mode. If the setting mode for opening the screen of the computer is the automatic mode, the BIOS reads the stored default value (angle value between the screen and the base) that is stored in the CMOS memory when the computer is turned off at the previous time. If the setting mode for opening the screen of the computer is the manual mode, the BIOS reads the default value (a manual setting value) from the CMOS memory. After the BIOS obtains the default value, the BIOS transmits the angle value or the manual setting value to a transmission controller. The transmission controller controls a transmission module to flip the screen to an angle according to the angle value or the manual setting value.

The present invention also discloses a method for automatically closing the screen of the computer. Firstly, the BIOS of the computer informs the transmission controller to perform a screen-closing operation for the computer, and the transmission controller records an angle value. After the screen of the computer is closed, the BIOS obtains a judging signal from the GPIO. When the judging signal is a screen-closing signal, the angle value in the transmission controller is stored. The computer having an automatic function for flipping a screen and the method for automatically flipping the screen of the computer utilizes the BIOS to control the screen the computer to be opened or closed when the computer is turned on or off. Furthermore, by storing the angle between the screen and the base when the computer is turned off, the screen of the computer is automatically flipped to a location with the stored angle when the computer is turned on again. Therefore, it is convenient for the user to use the computer, and the usage life of the jointed structure of the computer increases.

For further understanding of the invention, reference is made to the following detailed description illustrating the embodiments and examples of the invention. The description is only for illustrating the invention and is not intended to be considered limiting of the scope of the claim.

### BRIEF DESCRIPTION OF THE DRAWINGS

The drawings included herein provide a further understanding of the invention. A brief introduction of the drawings is as follows:

FIG. 1 is a schematic diagram of the appearance of the computer of the present invention;

FIG. 2 is a functional block of the present invention;

FIG. 3 is a flow chart of the method for automatically opening the screen of the computer of the present invention; and

FIG. 4 is a flow chart of the method for automatically closing the screen of the computer of the present invention.

### DETAILED DESCRIPTION OF THE PREFERRED EMBODIMENTS

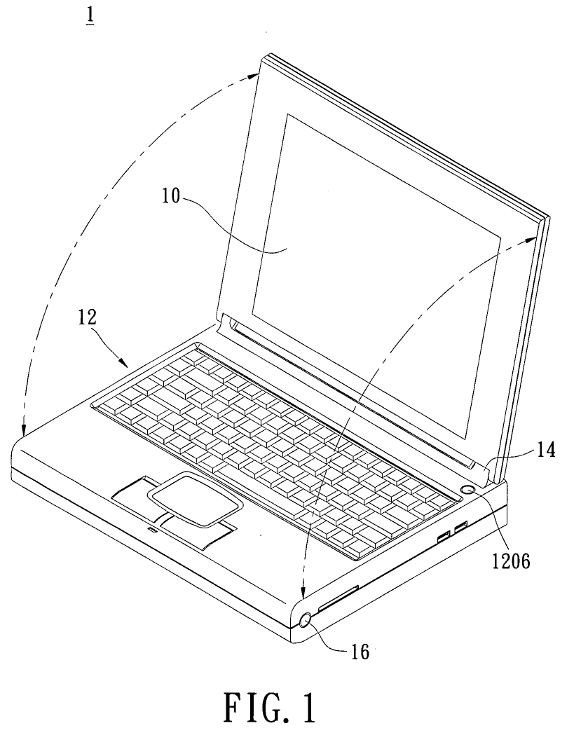

Reference is made to FIG. 1, which shows a schematic diagram of the appearance of the computer of the present invention. The computer 1 can be a laptop or a portable computer with a screen that can be opened or closed. In this embodiment, a laptop is used as an example.

Reference is made to FIG. 1 again. The computer 1 includes a base 12, a screen 10, and a transmission module 14. The transmission module 14 is pivoted between the base 12 and the screen 10, and is used for performing an opening operation and a closing operation between the base 12 and the screen 10. When a user presses the power switch 16 of the computer 1, the computer performs a starting procedure. At this time, the computer 1 utilizes the control and the setting of the inner BIOS to open the screen 10 to a location with an angle. Furthermore, when the computer 1 is turned off, the computer 1 utilizes the control and the setting of the inner BIOS to close the screen 10 onto the base 12, and stores the angle of the base 12 into the CMOS memory and is used for a reference for opening the screen 10 when the computer 1 is turned on again.

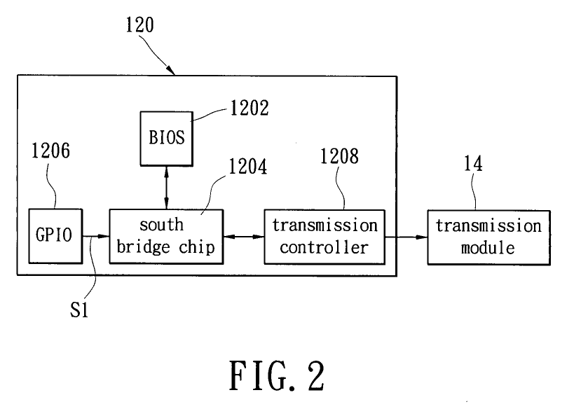

Reference is made to FIGS. 1 and 2. FIG. 2 shows a functional block of the present invention. In the base 12 of the computer 1, there is a motherboard 120. The motherboard 12 is installed with a BIOS 1202, a south bridge chip 1204, and a transmission controller 1208. The south bridge chip 1204 is electrically connected with the BIOS 1202 and the transmission controller 1208 for controlling the communication between the BIOS 1202 and the transmission controller 1208. The transmission controller 1208 is electrically connected with a transmission module 14, and is used for driving the transmission module 14.

Reference is made to FIGS. 1 and 2 again. The screen 10 is pivoted to the transmission module 14. According to the operation of the transmission module 14, the screen 10 performs an opening operation or a closing operation to the base 12. The transmission controller 1208 controls the transmission module 14 according to a default value in the BIOS 1202 to open the screen 10 or close the screen 10 onto the base 12.

The BIOS 1202 has a CMOS memory (not labeled), and the CMOS memory is used for storing the default value. The default value can be manually set by the user by entering the setting menu of the BIOS, or can be automatically set that uses the angle between the screen 10 and the base 12 when the computer was turned on for the previous time as the default value.

The motherboard 120 further includes a GPIO 1206. The GPIO 1206 is electrically connected with the south bridge chip 1204 for providing a judging signal S1 to the south bridge chip 1204. The judging signal S1 is used for determining whether the screen 10 is opened or is closed onto the base 14. The transmission controller 1208 has a counting unit (not labeled), and a register unit (not labeled). The counting unit is used for counting the angle between the screen 10 and the base 12 when the screen is opened or closed. The register unit is used for storing the operation status of the transmission controller 1208 and the angle.

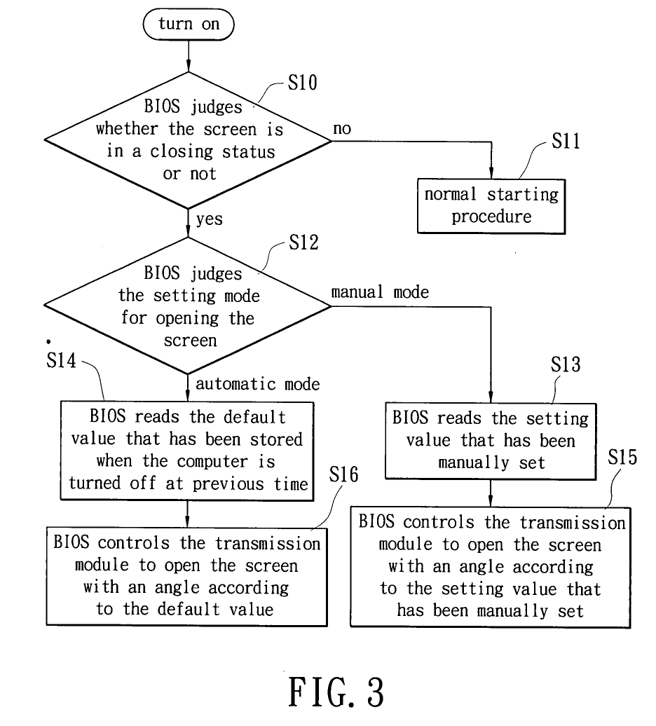

Reference is made to FIGS. 1, 2 and 3. FIG. 3 shows a flow chart of the method for automatically opening the screen of the computer of the present invention. When the computer 1 is performing the starting procedure, the control of the system is dominated by the BIOS. At this time, the BIOS detects the judging signal S1 outputted from the GPIO 1206 and stored in the south bridge chip 1204 to determine whether the screen 10 of the computer 1 is covered onto the base 12 or not (S10). When the screen 10 of the computer 1 is in a closing status, the BIOS determines the setting mode for opening the screen 10 (S12). The setting mode includes an automatic mode and a manual mode. When the screen 10 of the computer 1 is not in a closing status, the BIOS performs a normal starting procedure (S11).

When the setting mode for opening the screen of the computer is the automatic mode, the BIOS reads the default value (angle value between the screen and the base) from the CMOS memory (S14). The default value is a stored angle when the computer is turned off at the previous time. Next, the BIOS transmits the default value to the transmission controller 1208 via the south bridge chip 1204. The transmission controller 1208 uses the default value to drive the transmission module 14 to open the screen 10 to a location with an angle (S16). Alternatively, when the setting mode for opening the screen of the computer is the manual mode, the BIOS reads the default value from the CMOS memory (S13). The default value is set by the user implemented by entering the setting menu of the BIOS. Next, the BIOS transmits the default value to the transmission controller 1208 via the south bridge chip 1204. The transmission controller 1208 uses the default value to drive the transmission module 14 to open the screen 10 to a location with an angle (S15).

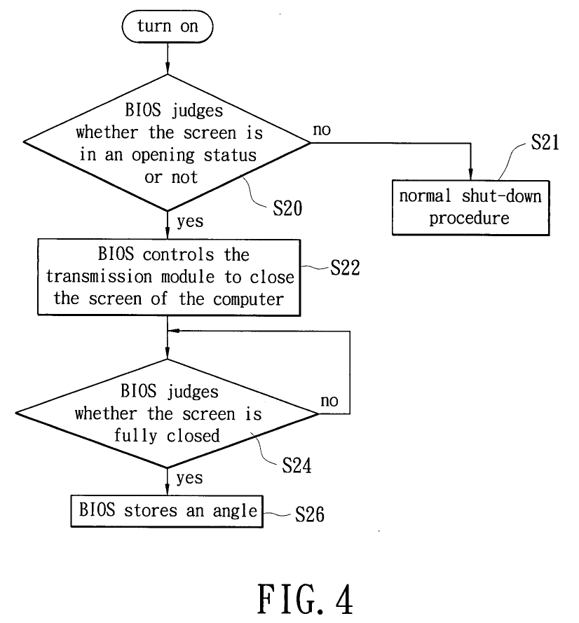

Reference is made to FIGS. 1, 2 and 4. FIG. 4 shows a flow chart of the method for automatically closing the screen of the computer of the present invention. When the computer 1 is performing the shut-down procedure, the operation system performs the specified shut-down procedure, and then the control of the system is dominated by the BIOS. The BIOS detects the judging signal S1 outputted from the GPIO 1206 and stored in the south bridge chip 1204 to determine whether the screen 10 of the computer 1 is opened from the base 12 or not (S20). When the screen 10 of the computer 1 is in an opening status, the BIOS controls the transmission controller 1208 via the south bridge chip 1204 to drive the transmission module 14 so that the screen 10 is covered onto the base 12 (S22). When the screen 10 of the computer 1 is not in an opening status, the BIOS performs a normal shut-down procedure (S21). In the step of S22, the counting unit of the transmission controller 1208 counts the angle between the screen 10 and the base 12, and stores the angel into the register unit. Next, the BIOS detects the judging signal S1 stored in the south bridge chip 1204 to determine whether the screen 10 of the computer 1 is fully covered onto the base 12 (S24). The judging signal S1 is generated and outputted by the GPIO, and is stored in the south bridge chip 1204. When the judging signal S1 detected by the BIOS and stored in the south bridge chip 1204 is in a closing status, the BIOS stores the angle stored in the register of the transmission controller 1208 into the CMOS memory, and is used as a reference for opening the screen 10 when the computer is turned on next time (S26). When the judging signal S1 is not in a closing status, the step S24 is repeated.

Therefore, when the computer 1 is shut down, the operation system performs the shut-down procedure, and the control of the system is dominated by the BIOS. At this time, the BIOS controls the transmission controller 1208 to drive the transmission module 14 to make the screen 10 of the computer 1 being covered onto the base 12. When the screen 10 of the computer 1 is fully covered on the base 12, the BIOS stores the operation record of the transmission controller 1208 in the CMOS memory of the BIOS. When the computer is turned on next time, the BIOS reads the default value from the CMOS memory and sets the default value to the transmission controller 1208. Thereby, the screen 10 of the computer 1 is opened to the location with a angle that has been stored.

Furthermore, the setting menu of the BIOS has an item that can be manually set. This means that the angle between the screen 10 and the base 12 can be manually set. Both the manual mode and the automatic mode cannot be enabled at the same time. If the automatic mode is selected, the manual mode is highlight and cannot be executed. If the manual mode is selected, the automatic mode cannot be executed.

When the computer is turned on or turned off, the BIOS also controls the opening operation and the closing operation between the base and the screen. Furthermore, when the computer is turned off, the angle between the screen and the base is stored. When the computer is turned on again, the screen is opened to the location with the stored angle. Thereby, it is convenient for the user to use the computer, and the usage life of the jointed structure of the computer is extended. The problem of the jointed structure being damaged by using a manual method and the inconvenient problem caused by adjusting the screen are overcome.

The description above only illustrates specific embodiments and examples of the invention. The invention should therefore cover various modifications and variations made to the herein-described structure and operations of the invention, provided they fall within the scope of the invention as defined in the following appended claims.

What is claimed is:

1. A computer having an auto-flipping screen, comprising:
a base having a motherboard, wherein the motherboard is installed with a BIOS, a south bridge chip and a transmission controller, the south bridge chip is connected with the BIOS and the transmission controller for controlling the communication between the BIOS and the transmission controller;
a transmission module pivoted with the base and electrically connected with the transmission controller, wherein the transmission module is controlled by the transmission controller; and
a screen pivoted with the transmission module, wherein screen performs an opening operation or a closing operation to the base according to the operation of the transmission module;
wherein the transmission controller controls the transmission module according to a default value in the BIOS to open or close the screen with an angle.

2. The computer having an auto-flipping screen as claimed in claim 1, wherein the screen is covered onto the base according to the operation of the transmission module, and the BIOS stores the angle between the screen and the base and uses the angle as a default value.

3. The computer having an auto-flipping screen as claimed in claim 2, further comprising a GPIO, wherein the GPIO is connected with the south bridge chip for providing a judging signal to the south bridge chip, and the judging signal is used for determining whether the screen is opened or covered onto the base.

4. The computer having an auto-flipping screen as claimed in claim 3, wherein the BIOS has a CMOS memory for storing the default value.

5. The computer having an auto-flipping screen as claimed in claim 4, wherein the transmission controller has a counting unit for counting the angle that the screen is opened from the base or covered onto the base.

6. The computer having an auto-flipping screen as claimed in claim 5, wherein the transmission controller has a register unit for storing the operation status of the transmission controller and the angle that the screen is opened from the base or covered onto the base.

7. The computer having an auto-flipping screen as claimed in claim 1, wherein the screen is automatically opened when the computer is turned on by utilizing the control and the setting of the BIOS.

8. The computer having an auto-flipping screen as claimed in claim 1, wherein the screen is automatically covered onto the base when the computer is shut down by utilizing the control and the setting of the BIOS.

9. A method for automatically opening the screen of the computer, comprising:
reading a default value by a BIOS; and
informing a transmission controller by the BIOS to perform an opening operation for a screen, wherein the transmission controller controls a transmission module to open the screen with an angle according to the default value.

10. The method for automatically opening the screen of the computer as claimed in claim 9, further comprising a step of determining that a setting mode of opening the screen is an automatic mode or a manual mode by the BIOS before the step of reading a default value by a BIOS.

11. The method for automatically opening the screen of the computer as claimed in claim 10, wherein the default value read by the BIOS is an angle when the automatic mode is selected.

12. The method for automatically opening the screen of the computer as claimed in claim 10, wherein the default value read by the BIOS is a setting value that is manually set when the manual mode is selected.

13. The method for automatically opening the screen of the computer as claimed in claim 10, wherein the BIOS determines whether the screen is fully covered onto the base according to a judging signal outputted from a GPIO before the step of further comprising the step of determining that a setting mode of opening the screen is an automatic mode or a manual mode.

14. The method for automatically opening the screen of the computer as claimed in claim 9, wherein the BIOS has a CMOS memory for storing the default value.

15. A method for automatically closing the screen of the computer, comprising:
informing a transmission controller by a BIOS to perform a closing operation for a screen;
recording a angle by the transmission controller according to the closing operation;
outputting a closing status signal by a GPIO; and
storing the angle of the transmission controller by the BIOS according to the closing status signal.

16. The method for automatically closing the screen of the computer as claimed in claim 15, wherein the BIOS determines whether the screen is in an opening status according to a judging signal outputted from a GPIO before the step of further comprising the step of informing a transmission controller by a BIOS to perform a closing operation for a screen.

17. The method for automatically closing the screen of the computer as claimed in claim 15, wherein the BIOS has a CMOS memory for storing the default value.
